(19) United States
(12) Patent Application Publication
(10) Pub. No.: US 2011/0022472 A1
(43) Pub. Date: Jan. 27, 2011

(54) PAYMENT SYSTEM AND METHOD

(76) Inventor: Ludwik F. Zon, Charlotte, NC (US)

Correspondence Address: Nelson Mullins Riley & Scarborough LLP;IP Department, 100 North Tryon Street, 42nd Floor, Charlotte, NC, 28202-4000, US

(21) Appl. No.: 12/713,100

(22) Filed: Feb. 25, 2010

Related U.S. Application Data
(60) Provisional application No. 61/155,479, filed on Feb. 25, 2009.

(51) Int. Cl. G06Q 30/00; G06Q 40/00; G06Q 20/00

(52) U.S. Cl. 705/14.64; 705/26.1; 705/39; 705/44

(57) ABSTRACT

A payment system and method employing wireless capability where a wireless-enabled device carried by a purchaser communicates with a wireless-enabled transaction terminal. The two devices communicate with each other to exchange transaction data to effect the transaction and exchange additional information that supports and expands the transaction event.

### CLAIM OF PRIORITY

The present application claims the benefit of the United States provisional patent application filed on Feb. 25, 2009 by Neerings, et al., entitled “Payment System and Method” (Ser. No. 61/155,479), the entire disclosure of which is hereby incorporated by reference for all purposes as if set forth verbatim herein.

### FIELD OF THE INVENTION

The present invention relates generally to payment systems and methods. More particularly, the present invention relates to a payment system and method employing wireless capability. In one preferred embodiment, a wireless-enabled device carried by a purchaser communicates with a wireless-enabled device at a merchant. The two devices communicate with each other to exchange data in order to effect a transaction, as well as to exchange additional information that supports and expands the transaction event.

### BACKGROUND OF THE INVENTION

Wireless protocols are known for exchanging data between fixed or mobile devices that are local to each other, such as those set forth in the BLUETOOTH IEEE 802.15.1 and Wireless Fidelity (“WI-FI”) IEEE 802.11 standards. Today, most mobile telephones incorporate BLUETOOTH capability, and it is known to connect such telephones and other devices, such as portable personal computers, in a network of multiple devices, sometimes referred to as a “piconet.”

Payment systems generally require that an individual making a purchase present a payment card having payment information contained in a magnetic stripe on the card, such as a credit or debit card. Alternatively, the individual provides payment information orally or presents cash or a check.

### SUMMARY OF THE INVENTION

The present invention recognizes and addresses the foregoing considerations, and others, of prior art construction and methods.

In this regard, one aspect of the present invention provides a mobile device configured to effect a transaction with a transaction terminal involving a user having a payment account with an account number of a predetermined format. The mobile device comprises a transceiver configured to communicate wirelessly with the transaction terminal, a processing device operatively connected to the transceiver, and memory operatively connected to the processing device. The memory comprises an applet that, when executed by the processing device, causes the device to generate a payment number corresponding to, but different from, the account number, exhibiting the predetermined format to be used as a payment method to effect the transaction with the transaction terminal, wherein the payment number has a limited use and transmit the payment number to the transaction terminal once the transceiver has established a communication path with the retail device.

Another aspect of the present invention provides a method for effecting a transaction between a mobile device and a transaction terminal involving a payment account associated with an account number of a predetermined format issued by a financial institution to a user. The method comprises the steps of establishing a communication path between a transceiver of the mobile device and the transaction terminal, generating by the mobile device a payment number corresponding to, but different from, the account number, exhibiting the predetermined format to be used as a payment method to effect the transaction with the transaction terminal, wherein the payment number has a limited use, and transmitting the payment number via the transceiver to the transaction device once the transceiver has established the wireless communication path with the transaction device.

The accompanying drawings, which are incorporated in and constitute a part of this specification, illustrate one or more embodiments of the present invention.

### BRIEF DESCRIPTION OF THE DRAWINGS

A full and enabling disclosure of the present system and method, including the best mode thereof, directed to one of ordinary skill in the art, is set forth in the specification, which makes reference to the appended drawings, in which:

FIG. 1 is a schematic representation of a transaction system in accordance with an embodiment of the present invention;

FIG. 2 is a flowchart illustrating a use of the transaction system of FIG. 1;

FIG. 3 is a schematic representation of a transaction system in accordance with an embodiment of the present invention;

FIG. 4 is a flowchart illustrating a use of the transaction system of FIG. 3;

FIG. 5 is a flowchart illustrating a method for generating, encoding, and decoding a limited-use number to be used as a method of payment in accordance with an embodiment of the present invention; and

FIGS. 6, 7, 8, and 9 are flowcharts illustrating methods for generating, encoding, and decoding a limited-use number to be used as a method of payment in accordance with additional embodiments of the present invention.

Repeat use of reference characters in the present specification and drawings is intended to represent same or analogous features or elements of the system and method according to the present disclosure.

### DETAILED DESCRIPTION OF PREFERRED EMBODIMENTS

Reference will be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

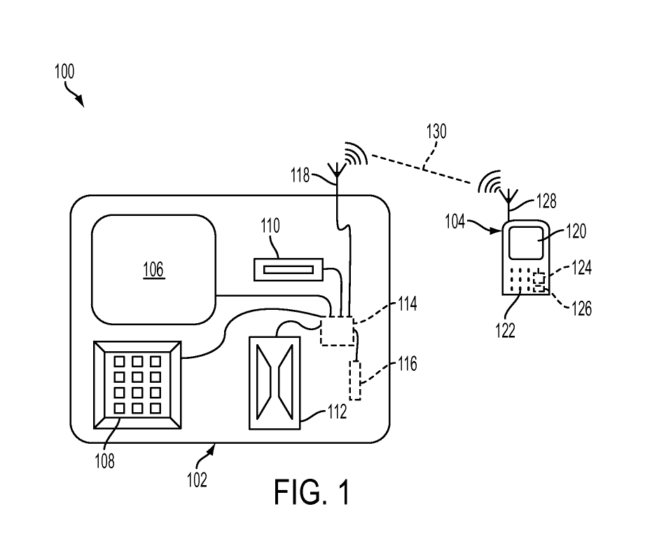

FIG. 1 illustrates a transaction system 100 comprising a transaction terminal 102 and a mobile device 104. Transaction terminal 102 comprises a display 106, a keypad 108, a smart card reader 110, and a magnetic stripe card reader 112, all of which are operatively connected to a processing device 114. Processing device 114 is also operatively connected to memory 116 and at least one wireless transceiver 118.

It should be understood that transaction terminal 102 is a device configured to effect retail or other transactions, for example, for goods or services purchased by a user. For instance, transaction terminal 102 may be part of a vending machine, such as a fuel dispenser, or of an automated teller machine (“ATM”), a hotel or airline kiosk, or any other device configured to effect a transaction. It should be further understood that transaction terminal 102 may not comprise all of the components set forth above depending on the use of the terminal, as well as other factors. For instance, smart card reader 110 may be excluded if transaction terminal 102 is located in a geographic region where smart cards are not prevalent, such as the United States. Likewise, it should be understood that transaction terminal 102 may comprise additional components configured to facilitate transactions, such as a cash and change acceptor or a contactless card reader, without departing from the scope of the present invention.

In one embodiment of the present invention, display 106 is replaced by a touch screen. In such an embodiment, it should be understood that the touch screen also functions as an input device. Display 106 may therefore be referred to herein as touch screen 106. Accordingly, keypad 108 may be excluded in such embodiments.

Processing device 114 may be a processor, microprocessor, controller, microcontroller, or other appropriate circuitry. Memory 116 may be any type of memory or computer-readable medium that is capable of being accessed by processing device 114. For instance, memory 116 may be random access memory (“RAM”), read-only memory (“ROM”), erasable programmable ROM (“EPROM”) or electrically EPROM (“EEPROM”), CD-ROM, DVD, or other optical disk storage, solid state drive (“SSD”), magnetic disk storage, including floppy or hard drives, any type of non-volatile memories, such as secure digital (“SD”), flash memory, memory stick, or any other medium that may be used to carry or store computer program code in the form of computer-executable programs, instructions, or data. Processing device 114 may also include a portion of memory accessible only to the processing device, commonly referred to as “cache.” Thus, memory 116 may be part of processing device 114, may be separate, or may be split between the relevant processing device and a separate memory device.

Memory 116 comprises computer-executable program code or instructions that, when executed by processing device 114, perform a part of the processes described in more detail below. Memory 116 may also comprise one or more data structures for storing information, such as a database or a table. The computer-executable program code or instructions in this scenario, as should be known to those skilled in the art, usually include one or more application programs, other program modules, program data, firmware, and/or an operating system.

Wireless transceiver 118 includes an internal radio frequency (“RF”) antenna configured to send and receive RF signals. Wireless transceiver 118 incorporates data provided by processing device 114 into the RF signals transmitted by the antenna, which is typically accomplished by modulating a carrier signal, as should be understood in the art. Wireless transceiver 118 is also configured to extract and transmit to processing device 114 data contained in the RF signals received by the antenna. For simplicity, RF signals and the data contained therein that are transmitted or received by wireless transceiver 118 are referred to herein as being transmitted or received by transaction terminal 102. It should be understood that, while wireless transceiver 118 is illustrated as an external component of transaction terminal 102 in FIG. 1, it may instead be an internal component contained within the terminal's housing. Wireless transceiver 118 may be configured to communicate via any suitable wireless technology or standards, including BLUETOOTH, WI-FI, Worldwide Interoperability for Microwave Access (“WiMax”), and wireless mesh networks. It should therefore be understood that the type and configuration of wireless transceiver 118 may vary depending on the wireless technology or standard by which the transceiver is configured to communicate. In fact, transaction terminal 102 may comprise additional wireless transceivers, each of which may be configured to communicate using a different wireless technology or standard. For instance, wireless transceiver 118 may be configured to send and receive RF signals according to the BLUETOOTH standard, while another wireless transceiver included in transaction terminal 102 may be configured to communicate via the WI-FI standard.

Mobile device 104 comprises a display 120 and a keypad 122 operatively connected to a processing device 124. Processing device 124 is also operatively connected to memory 126 and at least one wireless transceiver 128. In one embodiment of the present invention, display 120 is replaced by a touch screen, which additionally functions as an input device. As a result, keypad 122 may be removed from such an embodiment. Display 120 may therefore be referred to herein as touch screen 120.

Processing device 124 and memory 126 may be any suitable components, such as those described above with respect to processing device 114 and memory 116, respectively. Memory 126 comprises computer-executable program code or instructions that, when executed by processing device 124, perform a part of the processes described in more detail below.

Wireless transceiver 128 includes an internal antenna configured to send and receive RF signals. Wireless transceiver 128 is configured to extract and transmit data contained in the signals received by the antenna to processing device 124 and to incorporate data received from processing device 124 into signals transmitted by the antenna. While wireless transceiver 128 is illustrated as a component external to mobile device 104 in FIG. 1, it should be understood that wireless transceiver 128 may be an internal component contained within the device's housing. It should further be understood that mobile device 104 could have multiple wireless transceivers, each of which may be configured to adhere to a different wireless standard or technology. In the ensuing explanation, data contained in the RF signals transmitted or received by wireless transceiver 128 is referred to herein as being transmitted or received, respectively, by mobile device 104.

It should be understood that wireless transceiver 128 is configured to utilize the same wireless technology or standards as that of wireless transceiver 118, thereby enabling mobile device 104 and transaction terminal 102 to communicate. The wireless communication path between mobile device 104 and transaction terminal 102 is represented by dashed line 130 in FIG. 1. While dashed line 130 indicates a direct connection between transceivers 118 and 128 as illustrated in FIG. 1, it should be understood that wireless communication path 130 may be an indirect connection via one or more access points or devices. The indirect connection may also include one or more wired connections or devices or a local area network (“LAN”).

Mobile device 104 may be any suitable device capable of processing data, such as a cellular, mobile, or smart phone, a portable music player, a personal digital assistant (“PDA”), a camera, a laptop, or any other handheld, portable, or mobile device. For instance, mobile device 104 may also be a watch, a portable radio, or a mobile gaming console.

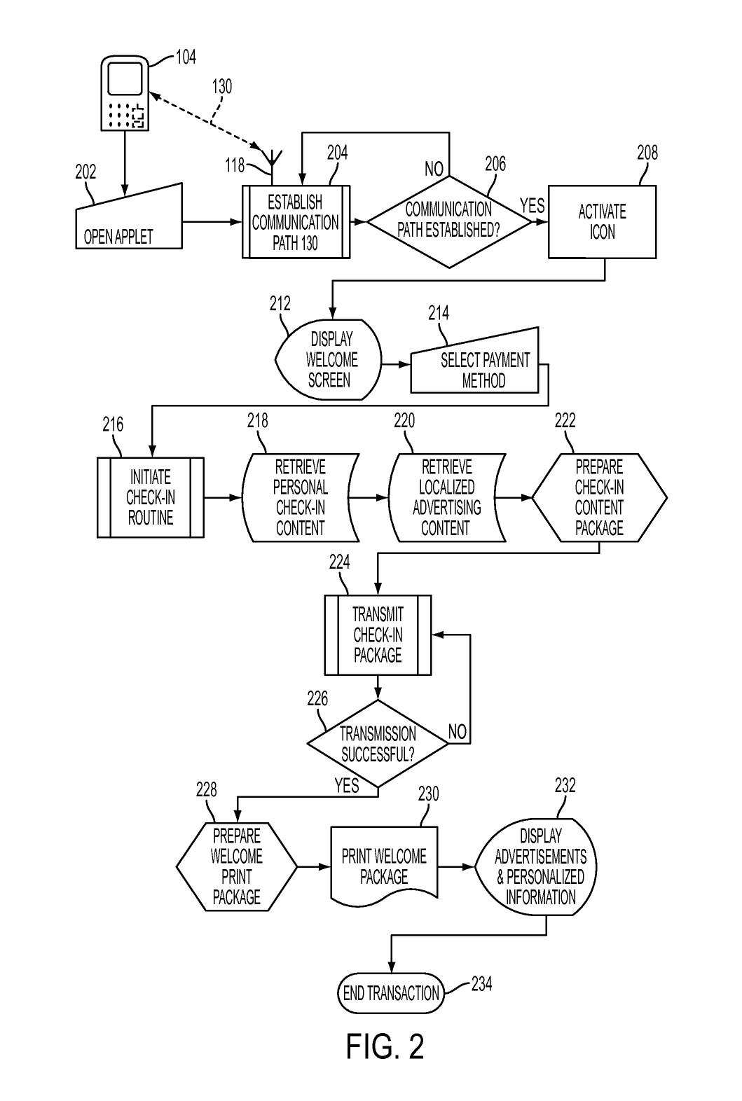

FIG. 2 illustrates one method by which a user of mobile device 104 effects a transaction. The description that follows explains the method with reference to reserving or checking into a hotel room, but it should be understood that the method is applicable to any suitable transaction, as explained in more detail below. That is, transaction terminal 102 is configured as a reservation system, a point-of-sale device (“POS”), or a kiosk in this example but may be any suitable transaction terminal depending on the specific environment.

At step 202, a user of mobile device 104 opens a computer program, which is typically accomplished by selecting an icon presented by the mobile device on display 120 depending on the specific model of the mobile device. Processing device 124 executes computer code or instructions stored in memory 126 which instruct display 120 to present preferably a graphical user interface (“GUI”) to the user. It should be understood that a command-line interface or terminal may be used instead of a GUI. The computer program may be an applet, module, plug-in, an Active-X control, etc. depending on the platform and operating system of mobile device 104, as should be understood in the art. Alternatively, the computer program may be configured to operate regardless of the specific platform and operating system. For instance, the computer program may be a JAVA applet configured to be executed by any platform. For purposes of the ensuing explanation, the computer program is referred to herein as an applet.

In the present example, the user of mobile device 104 has entered, and wishes to check into, a hotel, where the hotel's transaction terminal 102 is configured to facilitate the check-in procedure. A wireless network associated with the hotel is configured to cover at least a portion of the hotel. Mobile device 104 is configured to automatically connect to the hotel's wireless network when wireless transceiver 128 enters the area covered by the network. It should be understood that the wireless network may be accomplished via any suitable wireless technology, including Bluetooth and WI-FI. The wireless network may be radiated by one device, such as transaction terminal 102, or by one or more other devices, as explained below. Once mobile device 104 becomes part of the network at step 204, communication path 130 is established between the mobile device and transaction terminal 102, which transmits an identification of the goods or services offered by the terminal to the mobile device, in the manner described below. A computer program stored in memory 116 and executed by processing device 114 of transaction terminal 102 is configured to handle the interaction and communication with mobile device 104.

In an embodiment where wireless transceivers 118 and 128 are configured to communicate via the BLUETOOTH standard, transaction terminal 102 provides the wireless network and is a master device that can communicate with multiple slave devices in a piconet. The computer program of transaction terminal 102 causes wireless transceiver 118 to repeatedly and continuously transmit a query via BLUETOOTH transmissions, notifying BLUETOOTH-enabled slave devices within a reception area proximate to the terminal that it is present and available for wireless connection and communication. Mobile device 104 connects to transaction terminal 102 by pairing with the device, which is preferably accomplished by the “just works” secure simple pairing (“SSP”). That is, mobile device 104 automatically establishes communication path 130 with transaction terminal 102 by automatically pairing with the terminal. In one embodiment, communication path 130 is accomplished via a Logical Link and Control Adaption Protocol (“L2CAP”). It should be understood that transaction terminal 102 and mobile device 104 connect in a similar manner in an embodiment where transceivers 118 and 128 are configured to communicate in a wireless mesh network.

In an embodiment where wireless transceivers 118 and 128 are configured to communicate via the WI-FI or WiMax standards, an access point or similar device may provide the wireless network. Mobile device 104 automatically connects to the wireless network at which point the applet causes the mobile device to broadcast a query over the wireless network seeking transaction terminal 102. Mobile device 104 may be configured to broadcast the query using a certain protocol and/or a predefined port. Upon receipt of the query, transaction terminal 102 establishes communication path 130 with mobile device 104. Those of ordinary skill in the art will appreciate that the manner by which communication path 130 is established between transaction terminal 102 and mobile device 104 may vary depending on the specific wireless standard and/or technology used without departing from the scope of the present invention.

The applet of mobile device 104 is programmed to communicate and interact with the computer program executed by transaction terminal 102. At step 206, the applet and the computer program transmit and receive data to ensure that communication path 130 has been established between the two. If not, process flow returns to step 204 and repeats until communication path 130 is confirmed to exist. Once communication path 130 is established, the computer program of transaction terminal 102 transmits an identification of a category to which the terminal corresponds. That is, transaction terminal 102 transmits data indicating whether it is a vending machine, a hotel or airline kiosk, an ATM, etc. Transaction terminal 102 also identifies the goods or services it offers. For instance, if transaction terminal 102 is a vending machine, it provides a list of the goods it offers, whereas, if it is a hotel kiosk, it may provide a list of functions it provides, such as check-in and check-out services. In this example, transaction terminal 102 transmits data identifying that the terminal is a hotel kiosk or associated with a hotel and provides the option to check in. The applet presents an icon to the user via the GUI corresponding to the type of device of transaction terminal 102. In this example, the icon presented indicates that transaction terminal 102 is a hotel kiosk. For instance, the icon is a picture of a hotel. At step 208, the user activates the icon that represents transaction terminal 102. At step 212, transaction terminal 102 may optionally transmit to mobile device 104 a welcome screen to be presented by display 120 depending on the entity to which the transaction terminal corresponds.

Each type of commercial entity may require or request certain information from the user in order to effect a transaction. This information falls into two-categories: transaction information and entity-specific information. Transaction information is the information needed to effect a commercial transaction, such as a credit or debit card number, checking account number, or another type of payment account number. The transaction information may also include other necessary information, including, for example, a personal identification number (“PIN”), a card security code (“CSC,” “CVC,” “CVVC,” “CVV,” or “CV2”), an expiration date, and/or a billing zip code, as should be understood in the art. During installation of the applet, the user is asked to provide such information to mobile device 104 for each method of payment the user may want to use. The information required for each method of payment will depend on the method itself. For instance, the use of a credit card may not require a PIN. The applet stores a record in memory 126 of such information for each type of payment account the user may wish to use.

Entity-specific information is information the particular type of commercial entity may need or desire beyond the transaction itself, such as to maintain records or provide additional services or products ancillary to the transaction. Thus, also during installation or set-up of the applet, the user may enter user-specific data for each record corresponding to the different commercial entities. That is, the user may enter the non-transaction user data needed or desired to effect or enhance transactions for each specific entity type. For example, a hotel may require or request the user's name, address, work address, vehicle tag number, telephone number, electronic mail (“email”) address, and/or hotel or airline loyalty program membership number. Some or all of this information may be entered by the user into a “hotel” record stored in memory 126 of mobile device 104 and accessible by the applet. Correspondingly, the program(s) on the hotel's transaction terminal 102 may be configured to expect this information in the format in which it is stored on mobile device 104. It should also be known that certain information may be requested and used by transaction terminal 102 regardless of the type of commercial entity to which the terminal corresponds. For instance, transaction terminal 102 may request the user's name and address regardless of the type of commercial entity requesting the information.

Depending on the scenario, transaction terminal 102 may request that the user of mobile device 104 identify a payment method via the mobile device's applet at step 214. Using keypad 122 or touch screen 120 of mobile device 104, the user selects the desired payment method at step 214. For example, the user may select a credit card such as VISA, MASTERCARD, or AMERICAN EXPRESS, a debit card, or a checking account. In another embodiment, the user may select an option under which the applet generates a limited-use payment number, such as that disclosed in U.S. patent application Ser. No. 12/250,416, entitled “Electronic Transaction Security System and Method,” filed on Oct. 13, 2008, the entire disclosure of which is hereby incorporated by reference for all purposes as if set forth verbatim herein.

If the user selects the option to generate a limited-use payment number, the applet requests that the user provide an activation/authorization code. The activation code is personal to the user and is not stored in memory 126, thereby providing security in preventing use of the payment feature by unauthorized users. The user provides the authorization code via keypad 126 or touch screen 120.

In one embodiment, the applet determines whether the number provided by the user is a valid authorization code before proceeding. For instance, the result of a “Luhn” check performed on the accurate activation code is stored in memory 126 during installation of the applet. A Luhn check, as described in U.S. Pat. No. 2,950,048 issued to H. L. Luhn, which is hereby incorporated by reference for all purposes as if set forth verbatim herein, should be understood by those of ordinary skill in the art and is not, therefore, described in more detail. If the result of a Luhn check performed on the authorization code provided by the user does not match the Luhn check stored in memory 126, the applet terminates.

In one embodiment, if the user fails to provide the correct authorization code, the applet may cause display 120 to present an error or explanation to the user that a valid activation code has not been provided. In another embodiment, providing an incorrect authorization code a predetermined number of times causes mobile device 104 to generate and transmit a number or code to transaction terminal 102 indicating a correct authorization code has not been provided. Upon receipt of the number or code, transaction terminal 102 transmits data indicating that an unauthorized user may be attempting to gain access to the applet or to mobile device 104. The data may be transmitted to the financial institute responsible for the user's account corresponding to the data stored in memory 126 as discussed below.

When the user selects the payment method at step 214, the applet retrieves (from the previously-stored information in memory 126, as described above) the payment information corresponding to the selected payment method and transmits the information to transaction terminal 102 in conformance with standard 8583 established by the International Organization for Standardization (“ISO 8583”). In the case of a limited-use number, the applet generates the transaction information as explained in more detail below. In this case, the activation code entered at step 204 may be used in generating the limited-use number. In one embodiment, mobile device 104 encrypts the information transmitted to transaction terminal 102. In an embodiment where a limited-use number is utilized, it should be understood from the description below that the number may be transmitted without encryption because the limited-use number is different from the payment account number to which it corresponds. Additionally, any unauthorized recipient of the limited-use number is unable to identify the underlying payment account number. It should be appreciated from the description of the limited-use number that follows that various types of restrictions may be applied to the number so that the risk of fraud from the number being detected or intercepted in transmission is contained. For instance, use of the number may be limited to a specific time frame, a specific merchant or retail establishment, or a specific number of uses, including a single use.

If the user selects a cash or check option at step 214, no payment transaction information is retrieved or generated. It should be understood that data may still be transmitted to transaction terminal 102 should the user select a cash or check option, such as data representative of the user's name and address, so that this information does not manually need to be provided to the hotel. It should also be understood that the particular type or method of payment selected by the user may vary, and that the present disclosure is not limited to a particular payment form.

The applet may cause display 120 to present a GUI requesting the user to initiate a transaction. In the present example involving a hotel, this may include a request for the user to initiate a check-in procedure, which may be initiated when the user selects a check-in icon presented by the GUI using keypad 122 or touch screen 120. At step 216, mobile device 104 initiates the check-in procedure, which may include retrieving previously-stored information about the user in memory 126, as described above.

In one embodiment, the data transmitted by mobile device 104 includes information that uniquely identifies and authenticates the user to transaction terminal 102. For instance, the information may include the user's login and password associated with the hotel chain's loyalty membership program. It should be understood that other information may be transmitted to identify and authenticate the user to transaction terminal 102, including a unique id, such as that disclosed in U.S. Patent Application No. 61/248,722, entitled “Electronic transaction security system and method,” filed on Oct. 5, 2009, the entire disclosure of which is hereby incorporated by reference for all purposes as if set forth verbatim herein.

At step 218, the hotel's transaction terminal 102 requests, and mobile device 104 transmits, the selected payment information, if any, and the selected stored information from memory 126 via wireless connection 130. In one embodiment, transaction terminal 102 transmits advertising content, such as a mobile coupon (“m-coupon”) or digital interactive media (“rich-media”) advertising content, to mobile device 104 at step 220. This information may be selected and transmitted based on the information received from mobile device 104. That is, the advertising information transmitted by transaction terminal 102 may be tailored to the user of mobile device 104 based on the information about the user provided by the mobile device, as well as other information such as the terminal's geographic location. Alternatively, the advertising information may be provided to mobile device 104 at step 230, as described in more detail below.

Using the transaction, payment, and/or personal information, transaction terminal 102 prepares a content package at step 222 and transmits the package to mobile device 104 at step 224. The content package provides information relative to the goods or services being provided. For example, in the presently-described scenario involving a hotel, the content package provides standard hotel check-in information, such as check-in time and date, departure date and check-out time, room rate, room tax and other applicable charges. Mobile device 104 transmits a confirmation to transaction terminal 102 that it has received the content package. At step 226, transaction terminal 102 determines whether the confirmation has been received. If not, this indicates that either mobile device 104 did not receive the content package or transaction terminal 102 did not receive the confirmation transmitted by the mobile device. In either situation, process flow returns to step 224 and repeats until transaction terminal 102 receives a confirmation from mobile device 104 that it has received the content package.

In one embodiment, transaction terminal 102 prepares check-in documents at step 228, which are printed at step 230, after the terminal receives the confirmation from mobile device 104. In another embodiment, the check-in documents are provided to the user of mobile device 104 via email or directly to the mobile device. If transaction terminal 102 did not provide the advertising package to mobile device 104 at step 220 as described above, the terminal provides the advertising package at step 230. In one embodiment, the advertising package is included in or printed along with the check-in material. Alternatively, the advertising package is included within or emailed along with the check-in material. As noted above, the material contained in the advertising package may be selected and personalized in response to the information transmitted by mobile device 104 to transaction terminal 102 regarding the device's user. For instance, the hotel's transaction terminal 104 may be operatively connected to a database in which personal preferences for the user are stored. If the user's membership loyalty number corresponding to the specific hotel is stored in memory 126 and was transmitted to transaction terminal 102, for example, the terminal may retrieve information corresponding to the membership number. Based on this information, transaction terminal 102 may select an advertising package tailored to the user of mobile device 104. The advertising package may be tailored based on other factors, such as the geographic location of transaction terminal 102 and/or mobile device 104.

In one embodiment, the applet presents the advertising content via display 120 at step 232. This may be instead of or in addition to the advertising content being printed or email at step 230. The GUI displayed by mobile device 104 is configured to allow its user to delete or store coupons or advertising material in memory 126 as desired. Furthermore, this information may notify the user of events or amenities available at the hotel. For example, the content may allow the user to select dinner reservations at a hotel restaurant by activating interactive content downloaded from the hotel's transaction terminal 102 to mobile device 104 that communicates with the terminal and, therefore, the greater hotel computer system, through wireless connection 130. If the downloaded content prompts for additional communications between mobile device 104 and transaction terminal 102, any such communications occur at this time. In one embodiment, any information requested by the downloaded content may be automatically transmitted by mobile device 104 to transaction terminal 102 if authorized to do so. In another embodiment, the downloaded content causes display 120 to present additional GUIs that may be configured to request information from the user. Any information provided by the user to mobile device 104 at this point is stored in memory 126, transmitted to transaction terminal 102, or both. The process terminates at step 234.

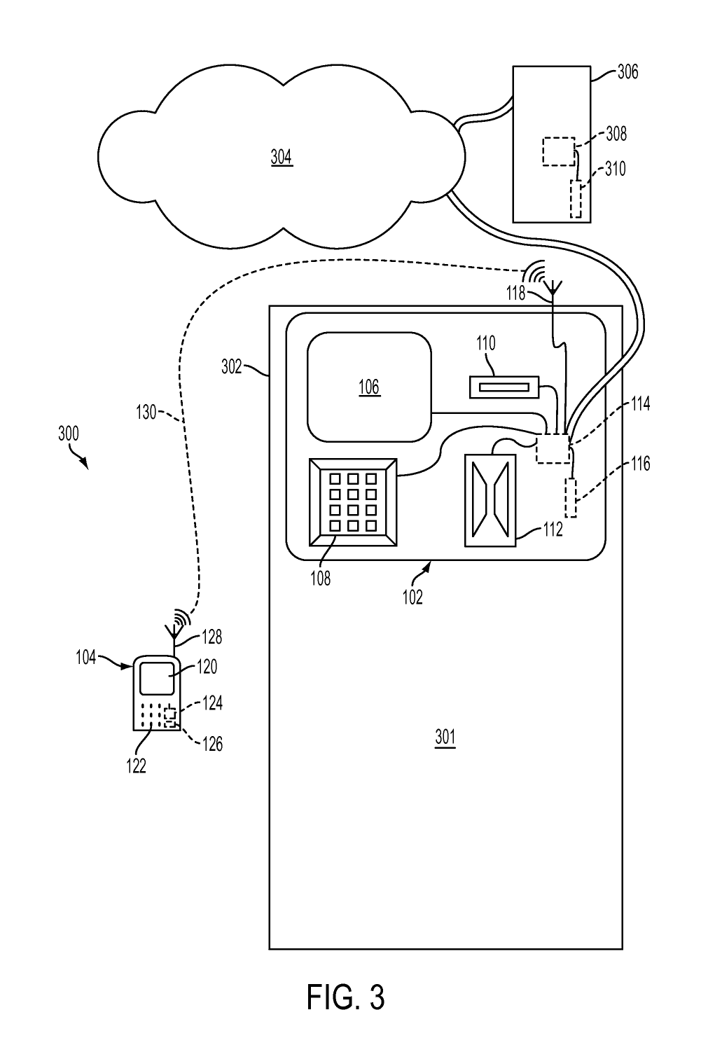

It should be understood that the method and system according to the present invention may be employed in effecting a variety of transactions, such as those involving a retail device that dispenses goods. For example, FIG. 3 illustrates a retail system 300 comprising a retail device 301 and mobile device 104. In the presently-described embodiment, retail device 301 comprises transaction terminal 102 within a housing 302 and is configured to dispense goods, similar in manner to a vending machine. Transaction terminal 102 and mobile device 104 are configured to communicate via wireless connection 130 as described above with respect to FIG. 1.

In this embodiment, processing device 114 is also operatively connected to a wide area network (“WAN”) 304, such as the Internet, to which at least one server 306 is also operatively connected. Server 306 comprises a processing device 308 operatively connected to memory 310, each of which may be any of the specific components described above with respect to processing device 114 and memory 116, respectively, of FIG. 1. In this embodiment, server 306 is maintained by a financial institution and is configured to effect retail transactions for accounts serviced by the financial institution, as should be understood in the art.

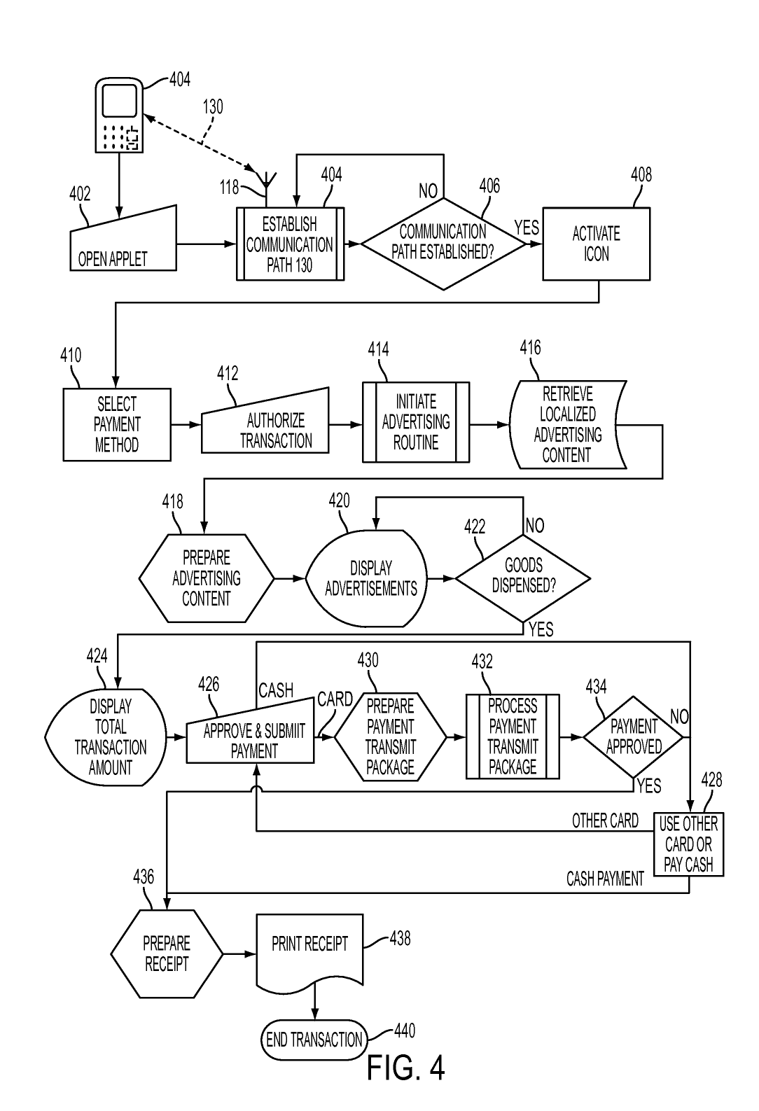

FIG. 4 illustrates a method by which a user of a mobile device 104 effects a purchase of goods or services from retail device 301 and provides payment for the dispensed goods or service using the mobile device. It should be understood that retail device 301 may be configured to operate as any suitable retail device, such as a fuel dispenser or a kiosk configured to dispense admission tickets to events and collect payment for the dispensed tickets.

Referring to FIGS. 3 and 4, an applet stored in memory 126 and executed by processing device 124 of mobile device 104 presents a GUI via display 120 corresponding to payment options for effecting the transaction. In one embodiment, a user selects an icon via keypad 126 or touch screen at step 402 in order to initiate the applet. The applet is similar in construction and operation to the applet described above with respect to FIGS. 1 and 2.

In the presently-described embodiment, the user of mobile device 104 approaches retail device 301 in order to pay for and receive the goods dispensed by the device. Wireless transceiver 118 of transaction terminal 102 is configured to transmit and receive RF signals according to at least one wireless technology or standard, similar to that described above with respect to FIGS. 1 and 2. In one embodiment, the area adjacent retail device 301 corresponds to a wireless network. Communication path 130 is established between retail device 301 and mobile device 104 at step 404 either directly or via a larger wireless network in a manner similar to that described above with respect to FIGS. 1 and 2.

A program stored in memory 116 and executed by processing device 114 of transaction terminal 102 is configured to handle interaction and communication with mobile device 104. Likewise, the applet stored in memory 126 and executed by processing device 124 of mobile device 104 is configured to handle interaction and communication with transaction terminal 102 and, thus, retail device 301. At step 406, retail device 301 and mobile device 104 exchange data to confirm that communication path 130 has been established. If not, process flow returns to step 404 and repeats until communication path 130 is confirmed. Otherwise, retail device 301 transmits a query including an identification of what type of device retail device 301 is. For instance, if retail device 301 is a vending machine, the query includes data identifying the retail device as a vending machine. Depending on the type of device, the applet executed by processing device 124 causes display 120 to present a GUI including an icon representative of the type of device. For example, if retail device 301 is a fuel dispenser, the GUI includes an icon identifying retail device 301 as a fuel dispenser.

The query may also include an identification of the specific retail device issuing the query. For instance, in an environment comprising multiple vending machines or fuel dispensers, the query transmitted by retail device 301 includes a number or other indicia in order to identify the retail device. For example, in a scenario where retail device 301 is a fuel dispenser, the retail device may be physically labeled with the number “1.” In this case, the query transmitted by transaction terminal 102 may include the number “1.” As a result, the GUI presented by the applet on display 120 may include a number or other indicia representative of each retail device located in the environment adjacent to the icon representative of the retail device. It should be understood that this is one way to identify retail device 301 when it is located among multiple, similar retail devices.

In another embodiment, the query includes an identification of all the retail devices in a defined area. For instance, retail device 301 may be the POS of a fuel station that comprises multiple fuel dispensers. The query transmitted by the POS (retail device 301) includes an identification by unique indicia of each fuel dispenser located in the fueling environment, as well as any other vending machines. It should be understood that this is another way to identify each vending machine associated with a POS and located in a specific area among similar vending machines. It should be understood that, in an embodiment where transceiver 128 is connected via communication path 130 to a transaction terminal 102 that is not the vending machine configured to dispense goods but is the device that provides an identification of the vending machines located in the environment, the vending machines do not need to comprise a wireless transceiver if they are operatively connected to the transaction terminal in another manner. At step 408, the user selects the icon corresponding to retail device 301 or to a specific vending machine with which the user desires to interact.

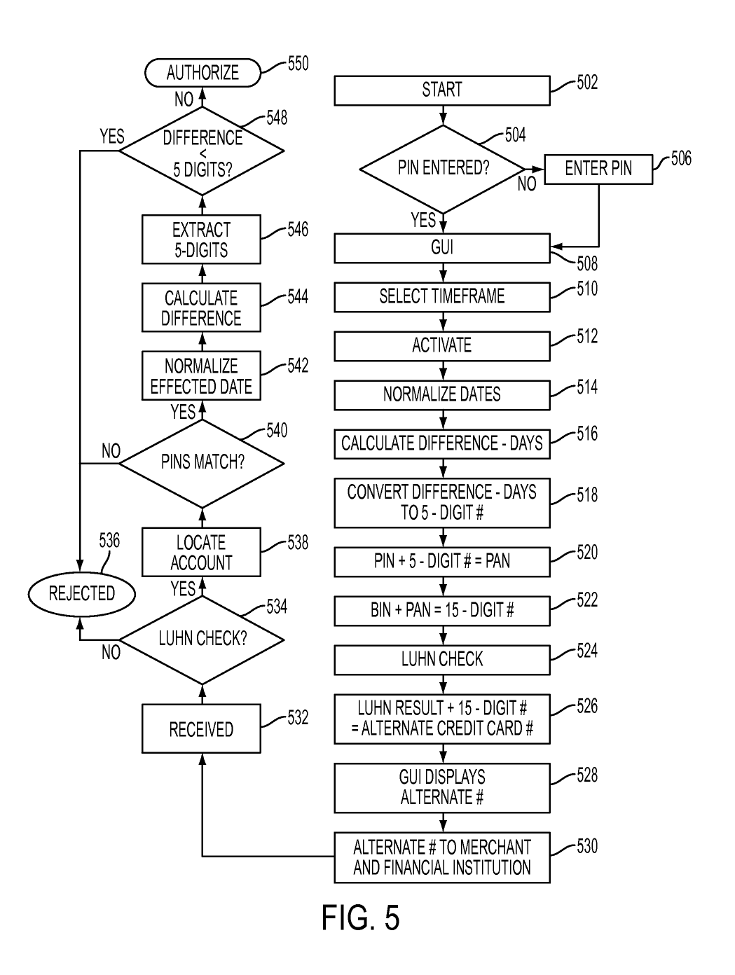

In an embodiment involving a retail device that does not require transactions to be preapproved, such as a snack machine, process flow proceeds to step 414. In an embodiment involving a retail device that requires preapproval, such as a fuel dispenser, process flow proceeds to step 410, where the user selects the method of payment from the GUI. Depending on the payment information provided by the user to mobile device 104, the options may include a credit, debit, checking, or limited-use account number. The GUI presents an icon for each payment option available to the user. If the user decides to use a limited-use account number, mobile device 104 generates the number in accordance with the processes described below with respect to FIGS. 5, 6, 7, 8, and/or 9. In another embodiment, the option to select a method of payment is not given to the user. That is, mobile device 104 automatically generates a limited-use number in the manner described below and includes the limited-use number in the payment information transmitted to transaction terminal 102.

At step 412, mobile device 104 transmits the payment information to transaction terminal 102. In one embodiment, the personal information stored in memory 126 is also transmitted to transaction terminal 102. At least a portion of the payment information and, in one embodiment, at least a portion of the personal information are transmitted to server 306 via WAN 304. Transaction terminal 102 may transmit the information via a POS, site controller, or other intermediary device, as should be understood in the art. The payment information may include a credit, debit, checking, or limited-use account number, as described above and as explained in more detail below. Based on the information it receives, server 306 determines whether to authorize the transaction, as should be understood in the art. Server 306 returns data representative of the determination to transaction terminal 102. Assuming the transaction is preapproved, process flow proceeds to step 414.

At step 414, prior to or while retail device 301 dispenses the relevant goods, the computer program executed by processing device 114 initiates an advertising routine. At step 416, the computer program retrieves and prepares advertising content, which is transmitted to mobile device 104 at step 418. The computer program may select advertising tailored to the user based at least in part on the personal information provided by mobile device 104 to transaction terminal 102 in a manner similar to that described above.

At step 420, mobile device 104 presents the advertisements to the user via display 120. In one embodiment, the applet is configured to continuously query transaction terminal 102 at step 422 to determine whether the dispensing of goods has occurred or has been completed. Additionally, the program of transaction terminal 102 is configured to transmit an indication to mobile device 104 when the dispensing has been accomplished. Once the dispensing process has been completed, transaction terminal 102 responds to mobile device 104 by transmitting data representative of the completion. Otherwise, mobile device 104 continues to display advertisements via display 120, which may include displaying multiple advertisements transmitted or streamed by transaction terminal 102 to the mobile device. In another embodiment, mobile device 104 displays advertisements via display 120 until it receives a confirmation from transaction terminal 102 that the dispensing of the good(s) has been completed. In either embodiment, once the dispensing has been completed, process flow proceeds to step 424. As mentioned above, the program of transaction terminal 102 and the applet of mobile device 104 are preconfigured to handle communications and interactions between the devices based on the category of the type of retail device 301.

At step 424, transaction terminal 102 displays information corresponding to the dispensed good(s) via display 106, such as the total amount for the transaction. Transaction terminal 102 may also transmit data representative of the information, including the final amount, to mobile device 104 to be presented by display 120. At step 426, the applet requests the user to select a form of payment, such as by a credit, debit, or checking account number, a check, or cash. The user may select a form of payment by using keypad 122 or touch screen 120. In an embodiment where preapproval is required, the applet may automatically select the form of payment provided by the user at step 410 and omit step 426.

If the user elects to pay by cash at step 426, the applet transmits data representative of the selection to transaction terminal 102 and process flow proceeds to step 428 and then step 436. If the user selects an option to pay with an account number at step 426, the applet displays a request to identify a particular account from among the records stored in memory 126. This may include a credit, debit, checking, or limited-use account number depending on the records created by the user. When the user selects a number, the applet retrieves or generates the payment information in a manner similar to that described above. Mobile device 104 transmits the selected payment information to transaction terminal 102 via wireless connection 130 and may also transmit the personal information stored in memory 126 to the terminal.

At step 430, the computer program executed by processing device 114 of transaction terminal 102 receives the payment and personal information from mobile device 104 and prepares a transaction payment request for communication to server 308 via WAN 304. At step 432, server 308 processes the transaction request in a manner that should be understood in the art or as described below with respect to the limited-use account number. At step 434, server 308 returns data to transaction terminal 102 indicating whether the payment is approved or denied. If payment transaction is denied, process flow proceeds to step 428, where the applet requests that the user select a different form of payment. In one embodiment, mobile device 104 causes display 120 to present the reason that the transaction was denied in order to provide the user with additional information. Process flow then proceeds to step 426 and proceeds in a manner similar to that described above.

If the payment transaction is accepted, transaction terminal 102 prepares a receipt for the transaction at step 436. At step 438, transaction terminal 102 prints the receipt using a nearby receipt printer, such as one that may be attached to retail device 301. Alternatively, transaction terminal 102 emails the receipt to the user's email as identified in the personal information stored in memory 126. In another embodiment, transaction terminal 102 transmits data representative of the receipt to mobile device 104 for the user to use as desired.

In one embodiment, transaction terminal 102 transmits an indication to mobile device 104 to terminate the advertisements presented by display 120. The process terminates at step 440.

FIG. 5 is a flowchart illustrating a method for generating, encoding, and decoding a limited-use number to be used as a payment method in a manner similar to that described above. As set forth above, the limited-use number is generated as a result of the user or mobile device 104 selecting a limited-use number as a method of payment. Referring to FIGS. 3 and 5, the generating and encoding processes are preferably implemented by the applet stored in memory 126 and executed by processing device 124 but can also be implemented by hardware, a person, or any combination thereof. The software implementing the decoding process is a standalone program stored on medium 310 of server 306 and executed by processing device 308. Alternatively, the software may be a module installed within the financial institution's corporate system.

During installation of the applet, information corresponding to the user's payment accounts is stored in memory 126, such as the user's name, telephone number, PIN, CVC code, expiration date, and/or billing zip code, as described above. In one embodiment, this information is retrieved from the financial institution (i.e., server 306) during the applet's installation. Alternatively, another medium storing this information is provided to mobile device 104, which transfers or copies the information to memory 126. For example, flash memory containing this information may be inserted into mobile device 104, or another device proximate to the user device may transmit the information wirelessly to mobile device 104 via Bluetooth, WI-FI, infrared light, or by any other suitable manner. The payment account number, however, is not provided to mobile device 104 and is not stored in memory 126.

At step 502, the user initiates the applet, which is retrieved from memory 126 and executed by processing device 124. The manner by which the user initiates the applet will be dependent upon mobile device 104, but may generally be initiated by launching the relevant program using the operating system of the mobile device. In one embodiment, each time the applet starts, it prompts the user to enter the activation code/PIN (via keypad 122 or the touch screen) supplied by the financial institution or selected by the user in order to gain access to the applet, as represented by steps 504 and 506, and as discussed above.

In one embodiment involving the generation of time-limited payment numbers, the applet may be configured to present a GUI providing the user with options associated with the generation and encoding of the time-limited number. The GUI may also be configured to display at least a portion of the payment information stored in memory 126, such as the expiration date of the underlying account. The GUI may also provide the user with the ability to determine the timeframe for which a time-limited number is valid, as explained in more detail below. The timeframes presented by the GUI may be varied depending on what selections are available to the user as acceptable timeframes as explained below. For example, the selectable timeframes may include individual days for the week following the time when the user accesses the applet. The GUI may also be configured to display the limited-use payment number generated by the process described below. It should be understood that the first six digits of a payment card number represent the BIN, which is the same for each alternate, limited-use payment card number generated by the process described below. It should be further understood that the BIN identifies the financial institution that issued the original payment card as described above or the financial institution that will validate and/or process transactions involving the generated time-limited or use-limited numbers. The financial institution may use the same BIN for the time-limited payment cards as it does for the original payment cards, or it may register or use a separate BIN for the limited-use payment cards in order to route transactions involving these payment cards to a specific processing center. In one embodiment, a portion of the BIN indicates to the financial institution that the payment number is a limited-use payment number rather than a static account number. The processing of the limited-use number in such an embodiment is routed to and handled by a device configured to process limited-use numbers. The following eight or nine digits represent the PAN, while the last digit represents a checksum. The PAN and checksum in the limited-use numbers are generated pursuant to the process described below. In this embodiment, the user selects a timeframe for which he desires a time-limited number to be valid at step 510. In another embodiment, the applet automatically selects the timeframe and generates the time-limited number. Process flow proceeds from step 504 to step 514. Likewise, in an embodiment involving the generation of a use-limited number, process flow proceeds from step 504 to step 514.

In an embodiment where the GUI provides the user with the ability to select a timeframe, the user selects a valid timeframe for which the user desires the time-limited payment card number to be valid. At step 512, the user initiates the generation and encoding of a number to be used as a payment method. At this point, the software normalizes the current date to 00:00:00 Greenwich Mean Time (“GMT”) regardless of the current actual time. That is, the software determines the current date and sets the time portion of the current date to 00:00:00 GMT. The software determines the current time based on the device time if not connected to the Internet. Based on the timeframe selected by the user at step 510 and the normalized current date, the desired expiration date of the time-limited payment card number is determined at step 514. It should be understood that the expiration date of the time-limited number is defined in terms of GMT in that the expiration time is set to 23:59:59 GMT (approximately midnight) on the date as selected by the user. For example, if the user selects a timeframe of “1 week” on January 12th at 1 pm Eastern Time, this time is normalized to January 12th at 00:00:00 GMT. Thus, the expiration date is set for January 19th at 23:59:59 GMT. In the presently-described embodiment, the expiration date of the user's payment card is considered to be 23:59:59 GMT as of the date set forth on the original payment card. It should be understood that any time zone and/or desired time may be selected to normalize the current date, desired expiration date of the time-limited number, and the payment card's expiration date, as long as the selected time zone and desired time are used consistently with respect to all three dates so that the three dates are analogous. That is, it is important that the three dates be converted to a common time zone for comparison.

At step 516, the applet calculates the number of days between the desired expiration date of the time-limited number and the payment card's expiration date. The number of days between the two is referred to herein as the “difference-days” for purposes of explanation. Since financial institutions generally do not issue payment cards having an expiration date greater than three years from the date of issuance, the value of the difference-days should be less than or equal to 1096 (assuming one of the three years is a leap year; that is, 365*3+1). At step 518, the applet determines the number of digits of the difference-days and appends zeros to the front of the difference-days until the length of the difference-days is five digits. The result is a 5-digit number representative of the expiration date of the time-limited number relative to the payment card's expiration date (i.e., the number of days before the payment card's expiration at which time the time-limited number will expire).

At step 520, the applet appends the 3- or 4-digit activation code/PIN entered by the user at step 506 to the front of the 5-digit number established at step 518, resulting in the PAN. It should be understood that the number of digits of the activation code/PIN or the number corresponding to the expiration date of the time-limited number may be varied depending on the number of digits available to the encoding process and desired use of the activation code/PIN, as set forth in more detail below. The software appends the PAN to the end of the BIN, resulting in a 15-digit number, at step 522. At step 524, a Luhn check is performed in order to generate the checksum/last digit of the alternate, time-limited number. At step 526, the applet appends the result of the Luhn check to the end of the 15-digit number established at step 522 to create a 16-digit alternate, time-limited payment card number. Optionally, the GUI displays the time-limited payment card number at step 528.

In one embodiment, mobile device 104 transmits this alternate, time-limited payment card number to transaction terminal 102 in order to effect a payment card transaction at steps 214, 412, and/or 426 as described above with respect to FIGS. 2 and 4. As described above, the payment information transmitted by mobile device 104 includes additional information, such as the CVC, PIN, expiration date, name, telephone number, and/or billing zip code associated with the user's payment card, as set forth in ISO 8583. Transaction terminal 102 transmits the alternate, time-limited number, the additional payment information, and the date on which the payment card transaction was effected to server 306 associated with the financial institution corresponding to the BIN, as described above with respect to steps 412 and 426 of FIG. 4. In the presently-described embodiment, this information is transmitted electronically via WAN 304, but may be accomplished by any other means, such as electronically or verbally over a telephone line if necessary.

Server 306 receives the information relevant to the payment card transaction from transaction terminal 102 at step 532. At step 534, the checksum digit of the alternate payment card number is extracted and compared to the result of a Luhn check of the BIN and PAN to ensure the alternate number may be a valid payment card number. If not, the transaction is rejected at step 536.

Otherwise, the financial institution software uses the other information transmitted by the merchant to the financial institution to locate the user's account, at step 538. The program matches the CVC, PIN, name, telephone number, expiration date, and/or billing zip code transmitted by transaction terminal 102 to the information associated with an account located within the financial institution's system. In another embodiment, a subset of this information, such as the name and telephone number or the CVC and telephone number, is used to locate the corresponding account maintained by the financial institution. If multiple payment cards are associated to the user or the account, the program uses the CVC and/or expiration date to identify the specific payment card to which the transaction relates.

In another embodiment, mobile device 104 transmits information capable of identifying the user, other than information corresponding to the user's payment card number, along with the time-limited number. The other information could be a device signature, such as a service-subscriber or international mobile subscriber identity (“IMSI”). An IMSI is a unique number associated with mobile device 104 and is able to uniquely identify the corresponding user within the financial institution's system as long as the IMSI is stored by the institution in the user's account. Alternatively, mobile device 104 transmits a sequence of alphanumeric characters unique to the user's account at the financial institution. The financial institution uses this unique sequence, which is stored in the user's account, in order to locate the user's account. It should be understood from the above description that the user's actual payment card number, or the PAN of the actual payment card number, is not required to locate the user's account.

At step 540, the financial institution program extracts the other four digits of the PAN and compares those digits to the activation code/PIN stored by the financial institution in the user's account identified at 538. If the extracted digits and the stored activation code/PIN do not match, the program rejects the transaction at step 536. It should be understood that the activation code/PIN may vary in length and may be, for example, three digits.

Otherwise, at step 542, the financial institution software normalizes the date on which the payment card transaction was effected to 00:00:00 GMT in a manner identical to that described above with respect to step 514. At step 544, the financial institution software calculates the number of days between the normalized transaction-effected date and the payment card's expiration date. At step 546, the software extracts the last five digits of the PAN of the alternate number and, at step 548, compares the extracted digits to the number of days determined at step 544. If the number of days calculated at step 544 is less than the extracted five digits, this indicates that the alternate, time-limited number has expired. The transaction is thus rejected at step 536. Otherwise, the transaction is authorized at step 550.

It should be understood that the above process allows the creation of an alternate payment card number that is valid for a length of time selected by the user. Thus, if the alternate number is stolen or otherwise becomes public information, the number will automatically be invalidated and unusable after the selected length of time. Additionally, if the information corresponding to the payment card transaction as described above is stolen or otherwise compromised, the possessor of the information is incapable of discerning the user's actual payment card number from the information. The above process allows the user to generate one unique time-limited payment card number for each day that the alternate number is desired to expire.

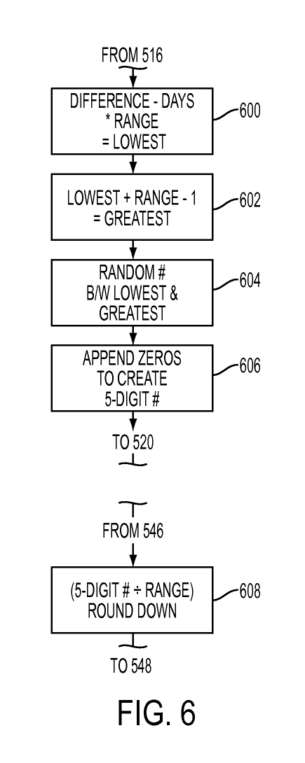

FIG. 6 illustrates an encoding and decoding process in accordance with another embodiment of the present invention. In this embodiment, the applet uses five digits of the PAN to represent the date on which the alternate, time-limited payment card number will expire, generated in the same manner as described above with respect to the embodiment of FIG. 5. Assuming five digits of the PAN are used for this date number, 500,000 different numbers (0 to 99,999) may be stored in these digits. The greatest amount of time that the user may select for the alternate number to expire coincides with the difference between the card's issue date and its expiration date. Since the expiration date of any payment card is usually three years or less from the date of issuance, the maximum time limit is most likely 1096 days (allowing for a leap year). Accordingly, 91 alternate, time-limited payment card numbers can be generated for each desired expiration date within the 3 years. That is, the 500,000 numbers divided by the 1096 days results in approximately 91 numbers per day. Thus, in the presently-described embodiment, each day within the three years is associated with a range of 91 numbers within the 500,000 available numbers. For example, the payment card's expiration date is associated with the first set of 91 numbers; that is, 0 through 90. The day prior to the payment card's expiration date is associated with the second set of 91 numbers—91 through 180; and so on.

The process illustrated in FIG. 6 is identical to that of FIG. 5 with respect to steps 500 through 516, and the number of days between the normalized, desired expiration date of the time-limited number and the payment card's expiration date is calculated at step 516 as described above with respect to FIG. 5. In the presently-described embodiment with respect to FIG. 6, the number of days determined at step 516 of FIG. 5 is multiplied by the day-range (91, in this case) to thereby find the smallest number within the range associated with the selected, desired expiration date, at step 600. The applet adds one less than the length of the day-range slotted for each day (90, in this case) to the smallest number (calculated at step 600) to thereby determine the greatest number within the range, at step 602. A random number generator effected in the user software and bounded by the smallest number (step 600) and greatest number (step 602) within the day-range creates a random number within the range at step 604. As described above, zeros are appended to the random number as necessary, at step 606, to generate a 5-digit number. This 5-digit number corresponds to the expiration date of the time-limited number in that it can be used along with other information associated to the actual payment card to determine the expiration date of the time-limited number. This number is appended to the activation code/PIN to form the PAN. The above process replaces the process described above with respect to step 518 of FIG. 5, and process flow proceeds to step 546 and continues in a manner identical to the process described above with respect to FIG. 5.

Still referring to FIG. 6, the financial institution program extracts the five digits representing the desired expiration date, at step 546. The financial institution program divides the extracted number by the day-range of numbers for each expiration date (91 in the presently described example) and rounds down to the nearest whole number or integer, at step 608. The result is the number of days between the desired expiration date of the alternate number and the payment card's expiration date. Process flow proceeds to step 548 and continues in a manner identical to that described above with respect to FIG. 5.

The process described above with respect to FIG. 6 provides the ability to generate multiple time-limited payment card numbers for each desired expiration date. Thus, for example, if the user generates multiple numbers for respective transactions, the system likely generates different numbers for most or all of the transactions. If one of the numbers is stolen, it may therefore be possible to identify the particular transaction involved, and thereby the particular vendor repository from which the number was stolen. It is also possible to generate additional time-limited numbers for a specific timeframe even after one such number becomes compromised.

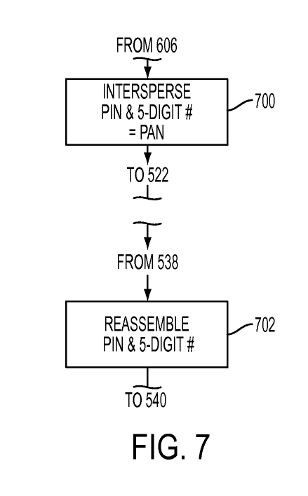

FIG. 7 illustrates an encoding and decoding process in accordance with another embodiment of the present invention. In this embodiment, process flow proceeds to step 606 in a manner identical to that described above with respect to FIG. 6. Step 520 (FIG. 6) is replaced by step 700 where the applet running on mobile device 104 creates the PAN by interspersing the activation code/PIN and the 5-digit number generated at step 606. For example, each digit of the activation code/PIN is inserted between two adjacent digits of the 5-digit number. It should be understood that the manner by which the activation code/PIN and the 5-digit number are interspersed or rearranged can vary as long as the financial institution reassembles the activation code/PIN and the 5-digit number using a corresponding method, as described below. Moreover, the method of interspersion can vary from one user to another.

Process flow continues to step 538 in a manner identical to that described above with respect to FIG. 6. At step 702, the financial institution program reassembles the activation code/PIN and the 5-digit number from the PAN in reverse of the manner by which the activation code/PIN and 5-digit number were interspersed at step 700. Continuing the example above, for instance, each digit of the activation code/PIN would be extracted from between the adjacent digits of the 5-digit number where they had been inserted. Process flow proceeds to step 540 and then continues in a manner identical to that described above with respect to FIG. 6. It should be understood that the above process intersperses the activation code/PIN associated with the user's payment card in order to obscure the activation code/PIN's visibility.

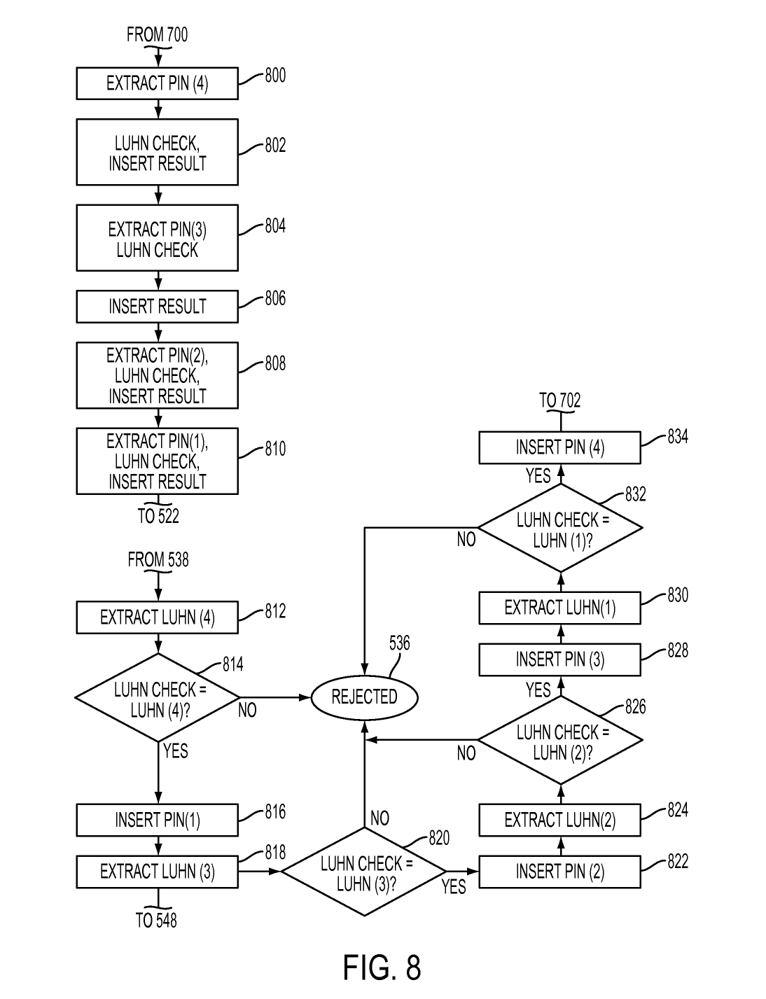

FIG. 8 illustrates another encoding and decoding process in accordance with another embodiment of the present invention. In this embodiment, process flow proceeds to step 700 in a manner identical to that described above with respect to FIG. 7. Because the applet is constructed to remember the location at which it inserted the digits of the activation code/PIN into the positions within the PAN, the applet extracts the last digit of the activation code/PIN, regardless of its location within the PAN at step 800. At step 802, the applet performs a Luhn check on the remaining 15 digits of the number and places the result in the location where the last digit of the activation code/PIN was extracted. At step 804, the user program extracts the third digit of the activation code/PIN and performs a Luhn check on the remaining 15 digits of the number. At step 806, the user program places the result of the Luhn check in the location where the third digit of the activation code/PIN was extracted. At step 808, the program extracts the second digit of the activation code/PIN and replaces it with the result of a Luhn check on the remaining 15 digits. At step 810, the program extracts the first digit of the activation code/PIN and replaces it with the result of a Luhn check on the remaining 15 digits. Process flow continues to step 538 in a manner identical to that described above with respect to FIG. 7.

The financial institution program is constructed to know the locations where the user program inserted the digits of the activation code/PIN into the PAN, and, thus, the locations where the Luhn checks replaced the digits of the activation code/PIN within the PAN. Thus, at step 812, the financial institution program extracts the number that replaced the first digit of the activation code/PIN and performs a Luhn check at step 814. If the result is anything other than the number extracted at step 812, the transaction is denied at step 536. Otherwise, at step 816, the financial institution program places the first digit of the activation code/PIN as stored in the user's account maintained by the financial institution in the location where the number was extracted at step 812. At step 818, the financial institution program extracts the number that replaced the second digit of the activation code/PIN and performs a Luhn check at step 820. If the result is anything other than the number extracted at step 818, the transaction is rejected at step 536. Otherwise, at step 822, the program places the second digit of the activation code/PIN as stored by the financial institution in the location where the number was extracted at step 818.

The financial institution program extracts the number that replaced the third digit of the activation code/PIN at step 824 and performs a Luhn check at step 826. If the result is anything other than the number extracted at step 824, the transaction is denied at step 536. Otherwise, at step 828, the financial institution program inserts the third digit of the activation code/PIN as stored in the user's account maintained by the financial institution into the PAN at the location where the number was extracted at step 824. At step 830, the financial institution program extracts the number that replaced the fourth digit of the activation code/PIN and performs a Luhn check at step 832. If the result is anything other than the number extracted at step 830, the transaction is denied at step 536. Otherwise, at step 834, the financial institution program places the fourth digit of the activation code/PIN as stored by the financial institution in the location where the number was extracted at step 830. Process flow proceeds to step 702 and continues in manner identical to that described above with respect to FIG. 7.

It should be understood that the above process changes each digit of the activation code/PIN, which is stored at different locations within the PAN of the time-limited payment card number. Additionally, the alteration of each digit is dependent on the other digits and the prior changes. Accordingly, if an attempt to use the time-limited payment card number involves changing any of the digits, the transaction will be denied. Moreover, the activation code/PIN is not visible within the PAN.

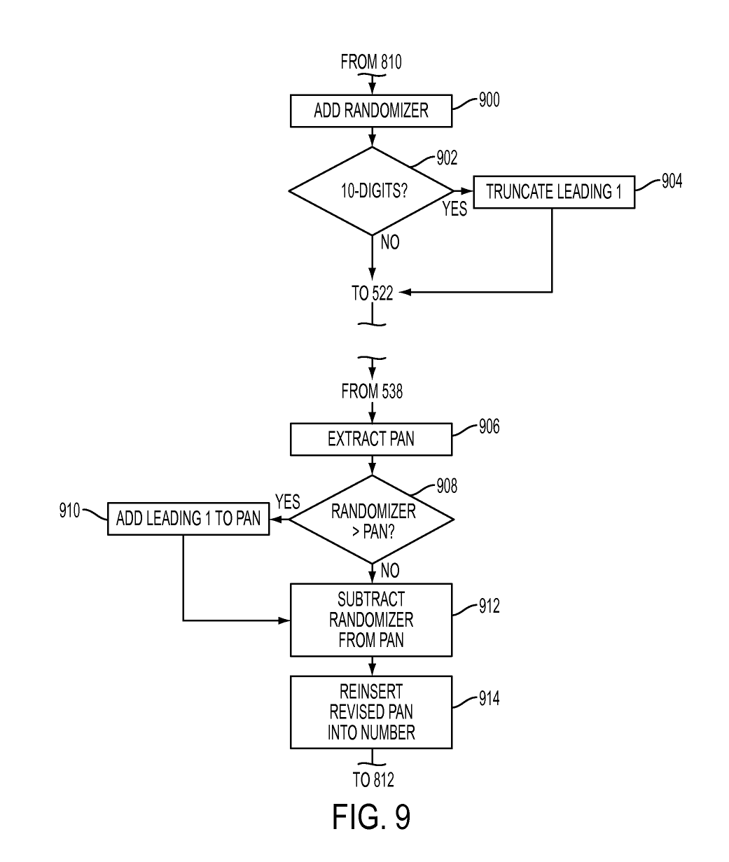

FIG. 9 illustrates an encoding and decoding process in accordance with another embodiment of the present invention, in which the information stored on mobile device 104 includes an eight digit random number specific to the user (referred to hereinafter as the “randomizer” for simplicity). The financial institution stores the randomizer in the user's account, for example, in memory 310 of server 308.

Referring to FIG. 9, process flow proceeds from step 502 to step 810 in a manner identical to that described above with respect to FIG. 8. At step 900, the applet adds (sums) the randomizer to the PAN generated at step 810. At step 902, the user program analyzes the length of the summation calculated at step 900. If the summation is a ten digit number, the leading “1” is truncated, resulting in a 9-digit PAN. Process flow proceeds to step 522, as it also would if the summation was not a 10-digit number (determined at step 900), and continues in a manner identical to that described above with respect to FIG. 8.

At step 906, the financial institution program extracts the PAN from the time-limited number. At step 908, the financial institution program compares the randomizer associated with the user's payment card stored by the financial institution to the 9-digit PAN. If the randomizer is greater than the PAN, a leading “1” is appended to the front of the PAN at step 910. The financial institution program subtracts the randomizer from the PAN at step 912. The program reinserts the resulting 9-digit PAN into the time-limited payment card number in the appropriate location—between the BIN and the checksum. Process flow proceeds to step 812 and continues in a manner identical to that described above with respect to FIG. 8.

The process described above with respect to FIG. 9 includes the addition of a random number specific to the user. This number is stored in memory 126 of mobile device 104 and in memory 310 of the financial institution's server 306. Any attempt to decode the time-limited payment card number generated by the above process without the randomizer will be unsuccessful.

With reference to FIG. 9, in another embodiment, the information stored on mobile device 104 (FIG. 3) includes two digits of a 4-digit validation number and six digits of the 8-digit randomizer. As set forth above, the financial institution maintains all the information corresponding to the user, including all four digits of the validation number and all eight digits of the randomizer.

The activation code/PIN entered by the user at step 506 is comprised of the other two digits of the 4-digit validation number and the other two digits of the 8-digit randomizer. It should be understood that the location of the remaining digits of the validation and randomizer number within the activation code/PIN may vary, provided that the applet is constructed to know the location of each digit. For example, the two digits of the validation number may be the first two digits of the activation code/PIN or the middle two digits, with the remaining two locations being occupied by the two missing digits of the randomizer. The digits may also be reversed with respect to how they should appear in the validation number and randomizer. For example, the last digit of the activation code/PIN may be the first digit of the complete validation number, and the first digit of the activation code/PIN may be the third digit of the complete validation number. Thus, it should be apparent that the location of each digit within the activation code/PIN is inconsequential on the condition that the software is constructed to identify the location of each digit.

In the present embodiment, the two digits of the validation number are extracted from the activation code/PIN entered by the user and joined to the two digits of the validation number within the file stored on memory 126 to produce the complete validation number at step 506. Similarly, the user program extracts the two digits of the randomizer number from the activation code/PIN and joins them to the six digits of the randomizer within the file stored on memory 126 to produce the complete randomizer at step 506. In the presently-described embodiment, the validation number replaces the activation code/PIN number for the remainder of the process, which proceeds to step 508 and continues in a manner otherwise identical to that described above. For example, the validation number (instead of the activation code/PIN) and the 5-digit number are interspersed at step 700 and reassembled at step 702. Process flow proceeds in a manner similar to that described above.

At step 548, the financial institution program compares the reassembled validation number to the validation number specific to the user maintained by the financial institution. If the validation numbers do not match, the transaction is denied at step 536. Otherwise, the transaction is validated at step 550.

The process described above prevents the information necessary to generate a time-limited payment card number from being accessible from a single location. That is, other than the financial institution, no entity or device possesses the entire validation number and/or randomizer, not even the user. Thus, if mobile device 104 is stolen, the culprit should be unable to generate a valid number without knowing the authentication code.

It should also be understood that the encoding and decoding processes described above are exemplary processes, and various processes may be used. Moreover, different processes can be used for one or more users so that the encoding and decoding process for one user may be different from the process for another user. As a result, the security of the above-described system and method is increased because discovery of the method associated with one user would be ineffective in compromising the confidential information of another user to which a different method has been associated.

Referring to FIGS. 3 and 9, in another embodiment, a file containing the information corresponding to the user's payment card, along with the two digits of the validation number and the six digits of the randomizer, is stored on memory 126 during installation of the applet. Alternatively, the file may be stored on memory 126 prior to or subsequent of the installation of the applet. The file may be downloaded from server 306 or from another computer maintained by a third-party operatively connected to mobile device 104, or may even be mailed via postal mail to the user by the financial institution or third-party.

It should be understood that the number of digits apportioned to the validation number and to the number representative of the desired expiration date of the time-limited payment card number may be varied depending on the available number of digits and the desired use of the digits without departing from the scope of the presently-described embodiments. For example, credit cards issued by AMERICAN EXPRESS are 15 digits in length, as compared to the 16-digit numbers discussed above. To accommodate for one less digit, a digit can be removed from either the digits allotted to the validation number or to the portion representative of the desired expiration date. Reducing the number of digits allotted to the desired expiration date changes the number of available time-limited credit card numbers per desired expiration day. For instance, reducing the number of digits for the number representative of the desired expiration from five to four reduces the number of different time-limited numbers that can be generated for each day from 91 to 9 (10,000÷1096). Furthermore, financial institutions associated with a specific BIN may authorize other financial institutions to use the same BIN. In this scenario, digits in the PAN following the BIN are used to identify which payment card numbers have been issued by the authorized institutions. Transactions involving payment card numbers that include the specific BIN are routed to the authorizing institution. The authorizing institution then routes the transactions to the authorized institution associated with the digits in the PAN set aside to uniquely identify the authorized institutions to which the relevant payment card number corresponds. In this case, digits within the PAN available for use in the processes described above are reduced. Digits in the PAN may also be allocated to indicate that the payment number is a limited-use number rather than a static account number, as well. The encoding and decoding process handles a reduced amount of available digits within the PAN as described above.

Furthermore, it may be desirable to allot more available, time-limited payment card numbers to one desired expiration date than to another. For instance, assuming five digits of the PAN are selected to represent the desired expiration date of the time-limited payment card number as described above, it may be desirable to allot half of the available numbers, or 50,000, to be used for time-limited numbers expiring on the same date as the actual payment card's expiration date. In this case, only the remaining 50,000 numbers are available for other expiration dates, thereby reducing the available numbers per desired expiration day to approximately 45 (50,000÷(1096−1)).

Similarly, it may be desirable to allow a set of time-limited numbers for a specific use. For example, it may be advantageous to allocate 50,000 of the available numbers to be used as single-use or use-limited payment card numbers. That is, each generated number based on one of these available numbers may be used once only. In such an embodiment, the user does not select a timeframe or an expiration date. Instead, the applet generates a time-limited number by randomly selecting a number from the available range of numbers. The process otherwise proceeds as described above. Once the random number is decoded and extracted from the time-limited number, the decoding program of the financial institution determines if it falls within the range of acceptable numbers and, if so, whether the number has been previously used. If the number has not been involved in a previous transaction, the financial institution authorizes the current transaction and removes the number from the list of useable numbers. Otherwise, the transaction is rejected. Thus, if another transaction includes the same number from the range of acceptable numbers, it will be rejected. This prevents a stolen or compromised, alternate number from being used again once it has been used in a transaction.

In addition, the length of the activation code/PIN issued by the financial institution may be varied without departing from the scope of the present invention. Furthermore, the purpose of each digit within the activation code/PIN may be varied depending on the desired encoding and decoding process. For example, the financial institution may issue a 5-digit activation code/PIN, wherein one of the digits is part of the validation number and the remaining four digits are part of the randomizer. In this instance, three digits of the validation number are stored on memory 126 of mobile device 104, and four digits of the randomizer are stored in memory.

It should also be understood that financial institutions may use both known and later-developed encryption methods and processes in conjunction with the above-described embodiments. Such encryption techniques may be use in combination with the above processes without the necessity to materially alter the processes described above. Furthermore, multiple encryption techniques may be used to aid the security methods described above without departing from the scope of the present invention.

It should be understood that the above description discloses a system and method for effecting a payment transaction via wireless technology using a single-use payment card number. That is, the single-use payment card number used in the transaction is only valid for that transaction, after which the financial institution corresponding to the number will reject any transaction attempting to reuse the number. In such an embodiment, it should be understood that the single-use payment number may be transmitted by a mobile device to a transaction terminal in the clear; i.e., without being encrypted. This is because any unauthorized recipient of the number will be unable to use it. Additionally, the limited-use number may be tied to the specific merchant based on information unique to the merchant, such as a merchant id. Accordingly, the limited-use number generated may be restricted to use at only that merchant, thereby preventing any unauthorized user from attempting to use the same number at other merchants.

It should also be understood that the above description discloses a system and method for effecting a payment transaction where a user's mobile device accomplishes all the necessary interaction with the user. In such an embodiment, the display and/or input devices may be removed from the transaction terminal, thereby greatly reducing the costs associated with the terminal. That is, since the user only interacts with his mobile device, the input and output devices of the transaction terminal are unnecessary.

While one or more preferred embodiments of the invention are described above, it should be appreciated by those skilled in the art that various modifications and variations can be made in the present invention without departing from the scope and spirit thereof. For instance, in the embodiments described above, a two-way information technology interchange is facilitated between the purchaser and the merchant that allows the purchaser to provide personal information (e.g., demographic information, transaction preferences, tax information, etc.) relevant to a particular transaction type and that allows the merchant to provide relevant information to the purchaser, for example related to logistics (facility information, rules, etc.) and marketing (interactive m-coupons, location-specific advertising, etc.) This occurs within the time window of the payment transaction. However, the particular information involved in a transaction may vary, and it should be understood that the examples provided above are not intended to limit the types of transactions or the relevant information encompassed by operation of the present invention. Also, for example, the particular procedure of a given transaction may vary, for example depending on the type of wireless protocol involved. It is intended that the present invention covers such modifications and variations as come within the scope and spirit of the present disclosure.

What is claimed is:

1. A mobile device configured to effect a transaction with a transaction terminal involving a user having a payment account with an account number of a predetermined format, the mobile device comprising:
a transceiver configured to communicate wirelessly with the transaction terminal;
a processing device operatively connected to the transceiver; and
memory operatively connected to the processing device and comprising an applet that, when executed by the processing device, causes the device to:
generate a payment number corresponding to, but different from, the account number, exhibiting the predetermined format to be used as a payment method to effect the transaction with the transaction terminal, wherein the payment number has a limited use;
transmit the payment number to the transaction terminal once the transceiver has established a communication path with the retail device.

2. The mobile device of claim 1 wherein the account number corresponds to a credit card.

3. The mobile device of claim 1 wherein the account number corresponds to a checking account.

4. The mobile device of claim 1 wherein the payment number is unusable after a predetermined amount of time.

5. The mobile device of claim 1 wherein the transceiver is configured to communicate with the transaction terminal using the BLUETOOTH standard.

6. The mobile device of claim 1 wherein the transceiver is configured to communicate with the transaction terminal using the WI-FI standard.

7. The mobile device of claim 1 wherein the applet is configured to cause the mobile device to encode the payment number.

8. The mobile device of claim 7 wherein the device encodes at least a portion of the payment number based on information stored in the memory.

9. The mobile device of claim 7 wherein the device encodes at least a portion of the payment number based on indicia associated with the payment account.

10. The mobile device of claim 1 wherein the applet is configured to cause the mobile device to encrypt the payment number.

11. The mobile device of claim 1 wherein:
the payment account is associated with a financial institution, wherein a first plurality of digits of the account number corresponds to the financial institution; and
the applet is configured to:
set a first plurality of digits of the payment number to the first plurality of digits of the account number;
set a second plurality of digits of the payment number to a randomly generated second plurality of digits within a predefined range of digits; and
set a last digit of the payment number to the result of a Luhn check on the first and second pluralities of digits in the payment number.

12. The mobile device of claim 11 wherein the predefined range of digits correspond to an expiration date associated with the account number.

13. The mobile device of claim 1 wherein the payment number is limited to a predetermined date range.

14. The mobile device of claim 1 wherein the payment number is limited to a single use.

15. The mobile device of claim 1 wherein the payment number is limited to use at a particular merchant.

16. A method for effecting a transaction between a mobile device and a transaction terminal involving a payment account associated with an account number of a predetermined format issued by a financial institution to a user, the method comprising the steps of:
establishing a communication path between a transceiver of the mobile device and the transaction terminal;
generating by the mobile device a payment number corresponding to, but different from, the account number, exhibiting the predetermined format to be used as a payment method to effect the transaction with the transaction terminal, wherein the payment number has a limited use; and
transmitting the payment number via the transceiver to the transaction device once the transceiver has established the wireless communication path with the transaction device.

17. The method of claim 16 further comprising transmitting personal information from the mobile device via the transceiver to the retail device.

18. The method of claim 17 further comprising receiving at least one advertisement from the retail device via the transceiver based on the personal information transmitted to the retail device.

19. The method of claim 16 wherein the payment number is limited to a single use.

20. The method of claim 16 wherein the payment number is limited to a predetermined timeframe.

21. The method of claim 16 wherein the account number corresponds to a credit card.

22. The method of claim 16 wherein the account number corresponds to a checking account.

23. The method of claim 16 wherein the transceiver is configured to communicate with the transaction terminal using the BLUETOOTH standard.

24. The method of claim 16 wherein the transceiver is configured to communicate with the transaction terminal using the WI-FI standard.

25. The method of claim 17 further comprising:
locating the payment account of the user based on the personal information; and
authorizing the transaction based on the payment number.

26. The method of claim 25 wherein authorizing the transaction based on the payment number comprised comparing at least a portion of the payment number to indicia associated with the payment account.

27. A method for identifying a user of a mobile device to a transaction terminal comprising the steps of:
establishing a communication path between a transceiver of the mobile device and the transaction terminal;
generating by the mobile device an alphanumeric code that both identifies and authenticates the user to the transaction terminal; and
transmitting the alphanumeric code via the transceiver to the transaction terminal once the communication path has been established.
